(19) United States
(12) Patent Application Publication
(10) Pub. No.: US 2011/0166903 A1
(43) Pub. Date: Jul. 7, 2011

(54) Web based Offshorability Probability Calculator - Job analysis Tool for Individuals made available on Internet

(76) Inventor: Sunmeet Singh Jolly, San Jose, CA (US)

(21) Appl. No.: 12/983,892

(22) Filed: Jan. 4, 2011

Related U.S. Application Data
(60) Provisional application No. 61/292,245, filed on Jan. 5, 2010.

(51) Int. Cl. G06Q 10/00

(52) U.S. Cl. 705/7.22

(57) ABSTRACT

The “Web based Offshorability Probability Calculator” is a system and method that allows an individual to determine the Probability of their job (OR any other job), or role within an organization getting sourced from an inexpensive offshore location. An internet based and a Microsoft EXCEL based embodiments of the tool have been detailed in this Patent application. Users access the Tool via Internet using their web browser (Internet Explorer or equivalent) to go to www.OffshoreProof.com or another website providing access to the tool. The user answers a set of questions related to their job using a simple Drop down Menu. Based on User Inputs and the pre-programmed decision matrix and weight assignment system, the calculator gives an output on the “Offshorability Probability” of the job along with a score and an analysis whether any technical or regulatory barrier could prevent Offshoring.

### CROSS-REFERENCE TO RELATED APPLICATIONS

This application claims the benefit of Provisional Patent Application Ser. No. 61/292,245 filed Jan. 5, 2010 by the present inventor, which is incorporated by reference.

### BACKGROUND

### Prior Art

The following is a tabulation of some prior art that presently appears relevant:

U.S. Patent Application Publications

| Publication No. | Pub. Date | Applicant |
|---|---|---|
| US 2008/0086354 A1 | Apr. 10, 2008 | Nagar |
| US 2008/0059387 A1 | Mar. 6, 2008 | Vaidhyanathan et al. |
| US 2007/0162321 A1 | Jul. 12, 2007 | Behrmann et al. |
| US 2007/0033060 A1 | Feb. 8, 2007 | Gopalan et al. |
| US 2006/0004596 A1 | Jan. 5, 2006 | Caniglia et al. |

Unless technical or regulatory barriers prevent doing so, in a truly global world, products and services are sourced from cheapest location in the world. Multinational corporations have been consistently downsizing staff from High Cost Geographies like USA, UK, Japan and moving Jobs to Low cost offshore locations like India, China, and Philippines thereby allowing them to create emerging markets for their Products and increase Profits for their corporations.

Companies have traditionally used expensive Consultants or Business Process Specialists charging anywhere from a few thousand to a few million dollars to carry out “Operational Analysis” to determine which Operations or Jobs they could move Offshore, and to which inexpensive geographies they could move them to.

“Offshorability” of a Job, Career, Profession, Business Process or Operation could be defined as the Probability that it could be sourced from an inexpensive “Offshore” location.

In the last decade, while working with several Offshore Outsourcing Firms and numerous Fortune 1000 Corporations, I've come across a lot of literature, tools and methodologies, dos and don'ts of outsourcing. Most Outsourcing Firms have proprietary methodologies to gather Client business process information and suggest Business Process Re-engineering to reduce costs by moving work offshore. Most of them end up sending their specialists to client sites for months to gather “AS-IS” Business Processes and then analyze and recommend “TO-BE” Processes with cost reduction achieved by Offshoring and Process Optimization.

There is hardly any standardization in this kind of analysis and methods & tools deployed vary from client to client and from one business process to another, and with consulting firms. A lot of Trial and Error goes into this with months of knowledge transfer and parallel run between the old (onsite) teams and new (offshore) teams, including the sad side of outsourcing—training your replacement.

Most of the Prior art referenced above focuses on Business Process Outsourcing, i.e. trying to document and claim a method and system for optimizing operational costs. They attempt to complement, supplement or claim something which has been going on for over two decades (offshore outsourcing) in one form or another and most large corporations have had first-hand experience in, whether it was getting a twenty people team in India work on a software project or a large thousand agent call center outsourced to Philippines. None of these Patents seem to have been granted yet.

Additionally, most Prior art tends to analyze any business operation as a whole focusing on “Tasks”, grouping certain tasks together to ship to low cost locations, eliminating jobs in high cost geographies to achieve lower total cost for organization and moving certain “tasks” to the team that remains Onsite and still employed with the organization.

While cost reduction for corporation remains the goal, most prior art ignores the “People” element. Employees often get a huge surprise when their companies announce a “layoff” or “downsizing” and move entire departments or portions of jobs to offshore locations to save money.

The “Web Based Offshorability Probability Calculator” (also referred to as “Job analysis tool” is designed to help remove a lot of Anxiety in Employees and empower them with the knowledge and decision making that company managements apply. The tool can also help in Career Planning for current and future career aspirants . . . they can decide to pick a profession or job that is “Offshore Proof” than to regret later.

Currently, No similar “Calculator” is available on internet that can help the individuals assess whether their Jobs can be done remotely from an inexpensive offshore location OR if their profession can have wage stagnation due to competition from offshore employees. Simple access to this “Offshorability Probability Calculator” (also referred to as “Job Analysis Tool”) can help users in “self assessment” of their jobs and can help them make “informed” career choices.

Another embodiment of this calculator could be used in Career websites to help Job search using an additional parameter of “Offshorability” (besides job location, salary, title, employer, duties etc). No commercial Job search website has enabled job search based on this (Offshorability) parameter and have not yet considered including this sensitive but important subject in their Career Advice sections.

Additionally, most Prior art focuses on claiming a process or method, but there is no precise attempt to build or claim a “Software Tool” or “Calculation Engine” that can take simple inputs, process them and give results in form of simple outputs. The present embodiment of “Job Analysis Tool” addresses this by making available this tool (calculator) on the internet, to the whole world (On website OffshoreProof.com). Detailed steps on building this tool in Microsoft EXCEL and HTML/JavaScript embodiments have been explained in this Patent application.

While most prior art focuses on Business Process level optimization and Cost reduction, some routinely ignore the “Technical or Regulatory Barriers to Offshore Outsourcing”. What if a Procurement Process passes all the tests of “Offshorability” but it is housed in a Federal Government department (with restrictions to shipping jobs offshore) or has Security Clearance requirements or Special Licensing requirements? The present embodiment of this Calculator takes into account Technical/Regulatory barriers while processing and displaying results on “Offshorability”.

Most prior art tends to focus on “Job Duties” or “Tasks” or “Geographic cost differentials” and “Computer/Telephony requirements” which are only a few of elements in deciding a job's “Offshorability”. Prior Art ignores additional key elements like “Education requirements for a Job”, “Annual Salary Levels”, “Department Size”, “Attrition levels in the profession”, “Training Requirements”, “Intellectual Property issues”, “Confidentiality”, “Ramp up or down requirements”, “Hardware/Industrial environment issues” and “Seasonal or Project Oriented nature of the job” all of which come into play in an Offshore Outsourcing decision and have been addressed and carry relevant weight in the present embodiment of “Web based Offshorability Probability Calculator”.

Although the primary motive of these embodiments of the tool is to help “individuals” or “employees” in assessing their jobs, this calculator can also be used as an inexpensive alternative by Corporations to decide on what jobs they could potentially source from an offshore location. In most cases, they end up spending thousands or millions of dollars in expensive consulting time to perform such an analysis at Business Operations level. The tool can also be used to supplement those findings or help in “preliminary assessment” to decide if a detailed operations analysis is necessary.

### DRAWINGS

### Figures

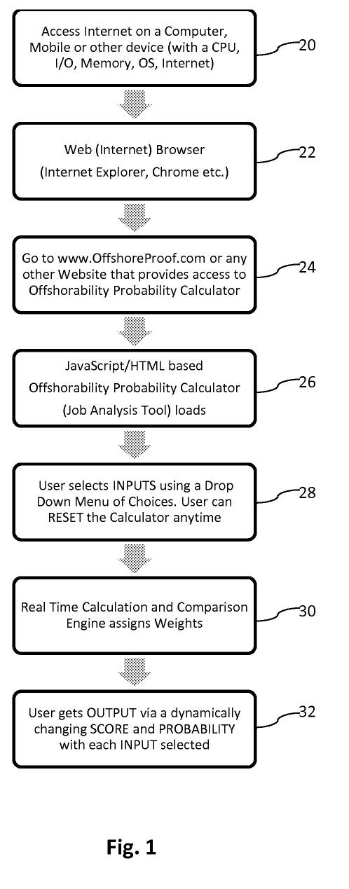

FIG. 1 is a flowchart illustrating User's access and high level operation of one embodiment of the calculator.

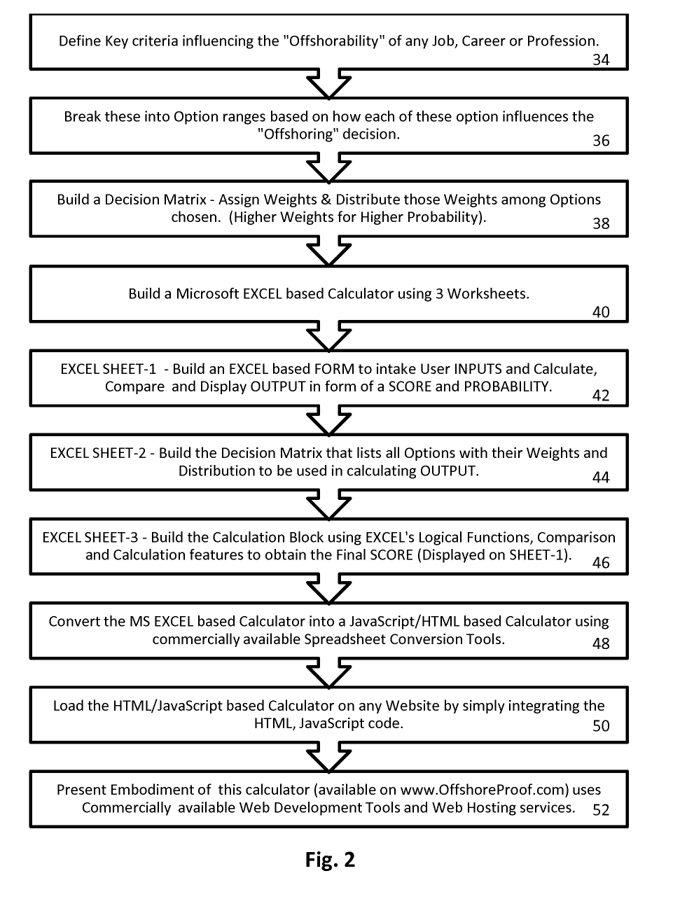

FIG. 2 is a flowchart illustrating steps used in building one embodiment of the calculator using Microsoft EXCEL and Web enabling it by converting it into another embodiment of calculator (HTML/JavaScript based).

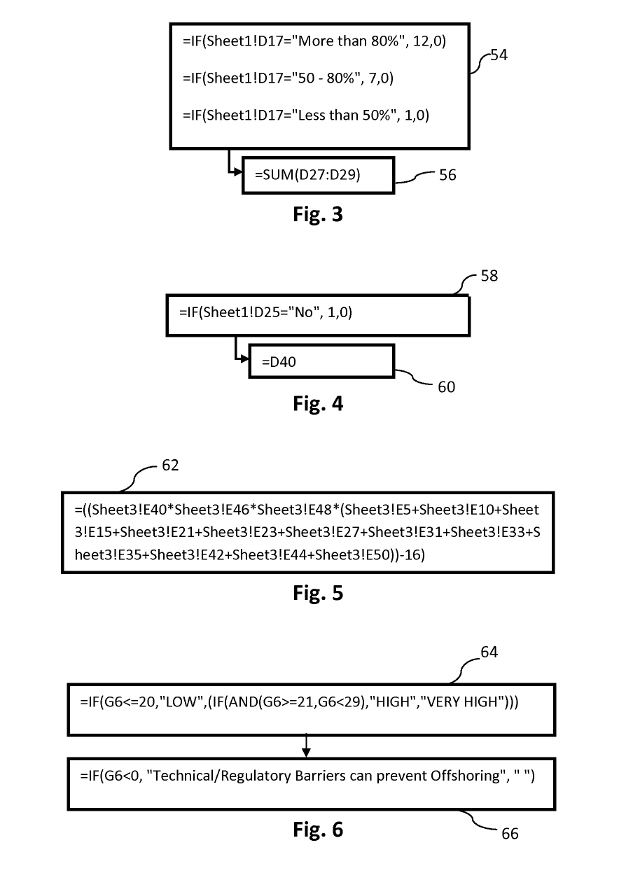

FIG. 3 is an illustration of how User Input is selected and Decision weight assignment accomplished using EXCEL's Logical and Mathematical functions.

FIG. 4 is yet another illustration of interpreting User Input and assigning decision weight using EXCEL's Logical function.

FIG. 5 is an illustration of EXCEL Formula with appropriate EXCEL Sheet and Cell references used to calculate SCORE to be Output to users.

FIG. 6 is an illustration of EXCEL's Formulas used to convert SCORE into Offshorability Probability ranges using EXCEL's Logical functions.

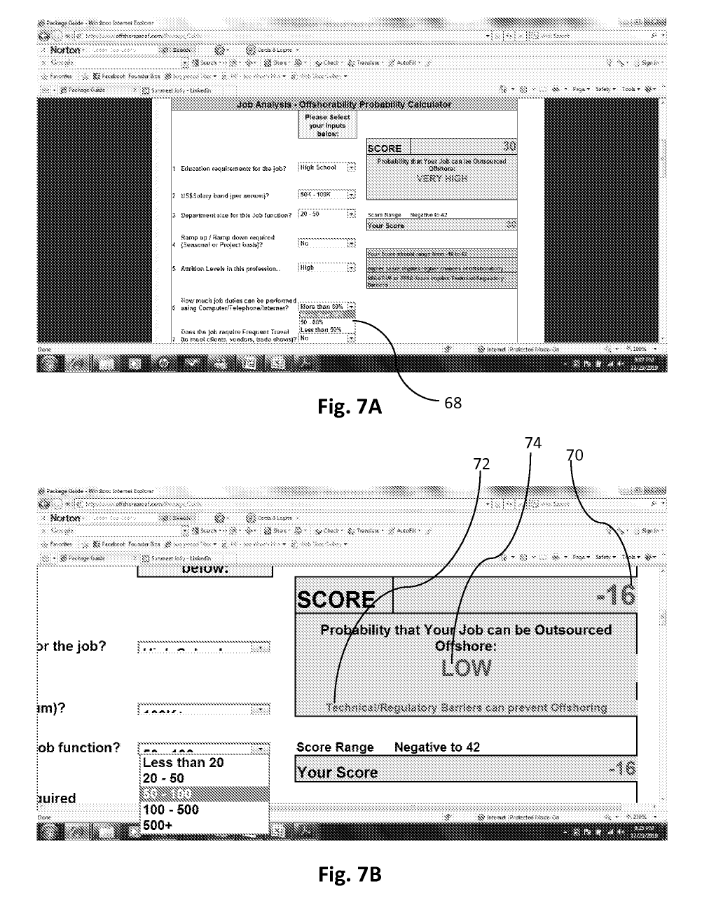

FIGS. 7A and 7B depict screens of one embodiment of Web based Offshorability Calculator available on the internet as fully functional working model that can be accessed on www.OffshoreProof.com.

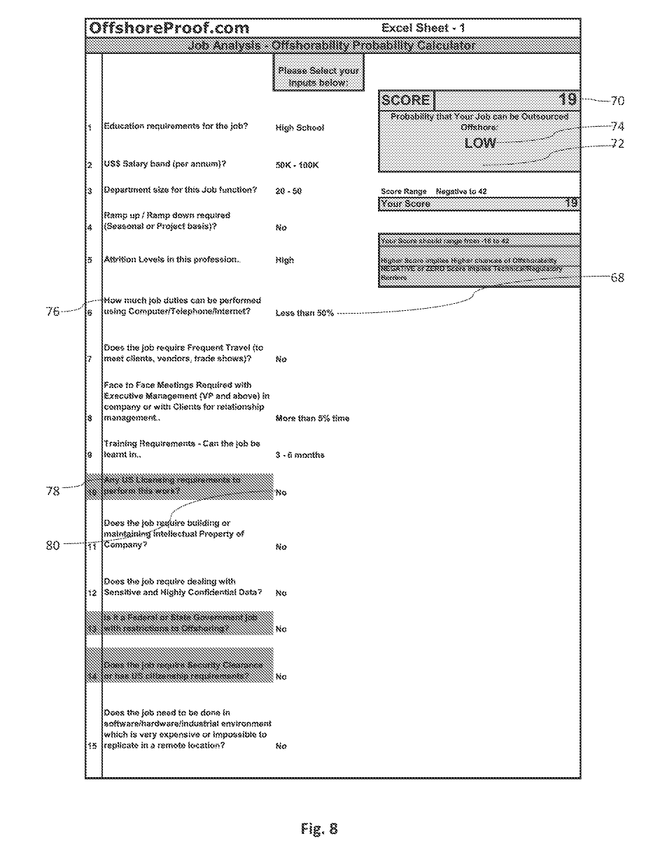

FIG. 8 depicts Sheet-1 of the Microsoft EXCEL based embodiment of Calculator, which is used to intake User inputs and display results.

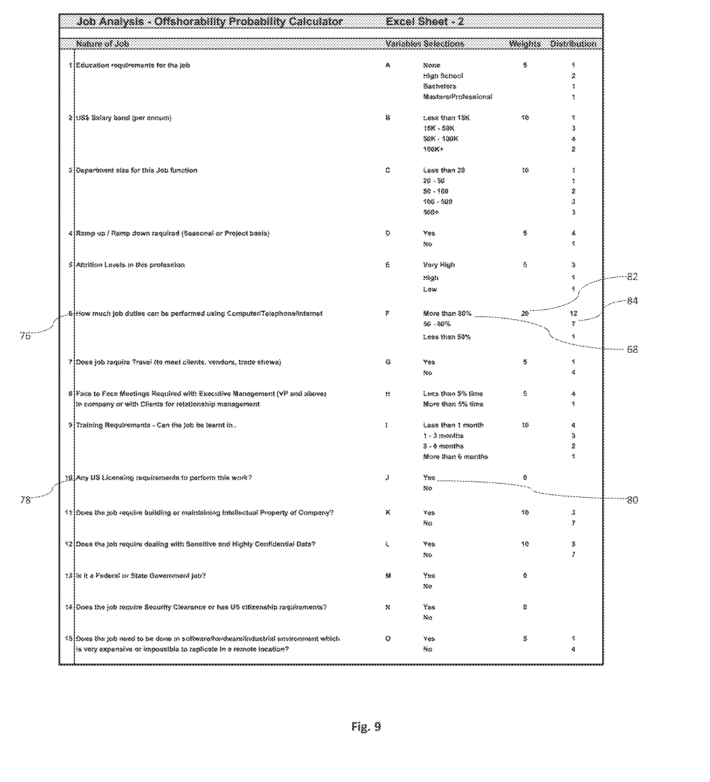

FIG. 9 depicts Sheet-2 of the Microsoft EXCEL based embodiment of Calculator, which is used to list all User Input Parameters, Possible Choices of User Selections and Distribution and Assignment of Decision weights to each of these Choices.

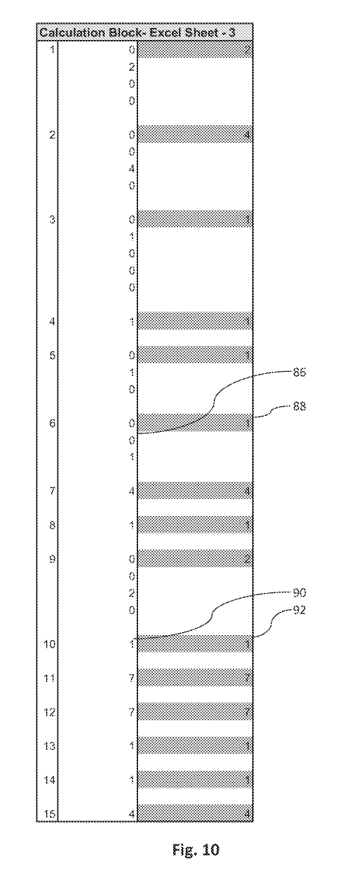

FIG. 10 depicts Sheet-3 of the Microsoft EXCEL based embodiment of Calculator, which houses the Calculation Block.

### DETAILED DESCRIPTION OF THE EMBODIMENTS

The following description is intended to convey a thorough understanding of the “Job Analysis Tool” by providing a number of specific embodiments and details involving a system and method for providing “Offshorability analysis” of an “individual job” in a high-cost geography. It is understood, however that the invention is not limited to these specific embodiments and details, which are exemplary only. It is further understood that one possessing ordinary skill in the art, in light of known systems and methods, would appreciate the use of the tool for its intended purposes and benefits in any number of alternative embodiments, depending upon specific design and other needs.

FIG. 1 is a flowchart illustrating User's access to and high level operation of one embodiment of the calculator. The Web enabled embodiment of the tool can be accessed using any Internet enabled Hardware device 20 such as a Personal Computer, Laptop, Cellular Phone, Video gaming system attached to a Television, Wi-Fi enabled Video Game, Tablet PC etc. The key components of such a system include an Input device (Keyboard, Mouse, Touch-screen, Game Controllers, Keypad etc.), an Output Display (Monitor, LCD Panel, Cell phone display, Television etc.), a Central Processing Unit (CPU), different types of Memory units (RAM, ROM, Hard Disc, Removable Media), Controllers and Interface devices, System Power and Clock Unit and an Operating System (Windows, Unix, Blackberry OS, iOS etc.).

In addition to hardware and operating software, the Web enabled embodiment of “Job Analysis Tool” requires a Web (Internet) Browser 22 and an internet connection (wireless or wired). The usage of HTML/JavaScript based calculator 26 on Internet Browser (Internet Explorer, Chrome etc.) requires that JavaScript or Active Scripting be “Enabled” in the Internet Browser. Web enabled embodiment of calculator may be accessed by visiting www.OffshoreProof.com 24 on the internet and clicking appropriate links on website to load the HTML/JavaScript based calculator 26. The tool may also be made available on other websites in present or different embodiments.

User is provided a Drop Down menu of choices to select their Inputs in step 28 and also provided a RESET button on top and bottom to RESET all selected inputs to default values. In step 30, as User selects their answers to each question, a real time Calculation and Comparison engine assigns Weights and in step 32 User can see the SCORE and its Offshorability Probability analysis dynamically change with each user Input.

FIG. 2 is a flowchart illustrating steps used in building one embodiment of the calculator using Microsoft EXCEL and Web enabling it by converting it into another embodiment of calculator (HTML/JavaScript based). The first important step 34 in building the tool is selecting the Key parameters by narrowing down on all available Criteria influencing the “Offshorability” of any individual's Job, Career or Profession. This requires extensive experience in the Offshore Outsourcing domain and was brought about using inventor's decade long work in this field (Fifteen such parameters have been chosen as User Inputs in present embodiments). Yet another domain specific step 36 is to break up the Chosen parameters into Option ranges based on how each of these options influence the “Offshoring” decision (Forty One such User selections have been included in the present embodiments as User Inputs to Fifteen questions). Yet another domain specific step 38 is to build a “Decision Matrix” by assigning Weights and Distributing those Weights among Options chosen. In present embodiments, Higher Weights have been assigned to Higher Offshorability Probability. FIG. 9 provides a comprehensive listing of all fifteen key parameters, all forty one user selection options, their weightage and distribution used in calculating final SCORE. Step 44 shows the inclusion of Decision Matrix in EXCEL SHEET-2.

Once the Domain specific model has been constructed (FIG. 9), the next step is to build the calculation engine. It is presently preferred that the Job analysis tool be programmed on Microsoft EXCEL Software, which is well known and commercially available, and could be downloaded into a PC, Laptop etc., but the embodiments are not limited to that combination of software and hardware. The Microsoft EXCEL based embodiment uses three Worksheets as provided in step 40. In this embodiment, Step 42 requires building EXCEL SHEET-1 (FIG. 8) that serves the purpose of a User Intake FORM and is used to Calculate, Compare and Display Output (Results) to Users. Step 44 requires inclusion of the Decision Matrix in EXCEL SHEET-2 (FIG. 9). Step 46 requires building a Calculation Block in EXCEL SHEET-3 (FIG. 10) using EXCEL's Logical and Mathematical Functions to process the Output.

To better understand the detailed programming and functioning of EXCEL based embodiment of this calculator, an illustration of EXCEL's Logical and Mathematical Functions and Formulae used in the calculator are provided in FIG. 3, FIG. 4, FIG. 5 and FIG. 6.

FIG. 8 illustrates the EXCEL SHEET-1 that is provided for Users to select their Inputs using a Drop Down menu. Results change dynamically and are Displayed on the top right hand box in form of SCORE 70 and Offshorability Probability analysis output box 74 and whether (or not) “Technical/Regulatory Barriers can prevent Offshoring” 72 applies.

In FIG. 8, in question no. six, user is asked—“How much job duties can be performed using Computer/Telephone/Internet?” 76 and is presented with following choices in the Drop Down menu 68—“More than 80%”, “50-80%” or “Less than 50%”. The Decision Matrix in FIG. 9 carries a Total Weight 82 of “20” points and a Distribution 84 of “12”, “7” and “1” corresponding to each user input. As User makes a selection, Formulae 54 and 56 (illustrated in FIG. 3) dynamically change values in corresponding cell blocks 86 and provide a total points assignment 88 corresponding to user selection (Calculation Block (FIG. 10)). These Formulae use EXCEL's Logical Function “IF” and Mathematical Function “SUM” to accomplish user selection and points assignment.

In FIG. 8, in another instance, in question no. ten, user is asked-“Any US Licensing requirements to perform this work?” 78 and is presented with following choices in the Drop Down menu 80—“Yes” or “No”. This important question is designed to check on whether any Technical/Regulatory Barrier to Offshoring exists, hence no weights are assigned by Decision Matrix (FIG. 9) but by using Formulae 58 and 60 (illustrated in FIG. 4), corresponding cell values 90 and 92 (equal to “1” or “0”) are obtained (Calculation Block (FIG. 10)). If user selection is a “Yes”, the Calculation engine assigns “0” and gives a negative or zero output based on Formula detailed in next step (used to calculate SCORE 70).

In FIG. 8, the SCORE 70 is calculated using the Formula 62 (illustrated in FIG. 5). This uses multiple EXCEL Sheet and Cell References and Mathematical functions to obtain SCORE 70. Qualitative results are provided to user in form of Offshorability Probability Analysis 74 and Technical/Regulatory Barrier Analysis 72 which are obtained using Formulae 64 and 66 (illustrated in FIG. 6). So in the present EXCEL based embodiment of this “Job analysis tool”, Users can select multiple inputs and obtain a SCORE 70 that ranges between “−16 to 42”. Users also get an Offshorability Probability analysis 74 of “LOW”, “HIGH” or “VERY HIGH”. Users also get results of the “Technical/Regulatory Barriers to Offshoring” test 72.

After building a fully operational Microsoft EXCEL based embodiment of the Offshorability Calculator, the next step is to Web enable it so it could be concurrently accessed and used by multiple users around the world on World Wide Web (Internet).

As illustrated in step 48 (in FIG. 2), the EXCEL based calculator is converted into HTML/JavaScript based calculator using commercially available Spreadsheet Conversion Tool (SpreadsheetConverter from Framtidsforum I&M AB, Sweden). This provides us with a HTML/JavaScript page with fully functional calculator loaded on it. The next step 50 is to integrate the HTML/JavaScript code in a Website which is accomplished as provided in step 52 by loading the calculator on www.OffshoreProof.com using commercially available web development tools and web hosting services (provided by GoDaddy.com, Inc.).

FIGS. 7A and 7B depict actual screens of the Web enabled embodiment of “Web based Offshorability Probability Calculator” available on internet as fully functional working model that can be accessed on www.OffshoreProof.com. It provides the same functionality, look and feel as created in the Microsoft EXCEL based embodiment of the Job analysis tool with the additional convenience of accessing it from anywhere in the world with any number of concurrent users wherever the internet is available and with a wide variety of hardware devices 20. User selects Input 68 via a drop down menu of choices and gets Output in form of SCORE 70, Offshorability Probability analysis 74 and Technical/Regulatory Barrier analysis 72 as each Input is selected.

While the above description contains many specificities, these should not be construed as limitations on the scope of any embodiment, but as exemplifications of various embodiments thereof. Many other ramifications and variations are possible within the teachings of the various embodiments. For example:

Additional Embodiments of this tool can be programmed using Object Oriented Programming languages like JAVA, C++ etc. and constructed in a Client-Server model. Additionally, Client side Scripting could be programmed using AJAX, PHP or VBScript as well. Any other Spreadsheet software may be used in lieu of Microsoft EXCEL.

Additional Embodiment of this tool could be used in Career Websites to help people make informed career choices based on Offshorability of a Job/Profession.

Additional Embodiment of the calculation engine could be integrated with Job search menu in the leading Career Websites to enable Job search based on an additional “Offshorability” Parameter besides Job Location, Experience, Salary, Title etc.

Additional Embodiment of this tool can be incorporated into Corporate Intranets of large Corporations to help Employees make informed career choices or timely career moves within the multi-national corporation, rather than be surprised by a layoff or downsizing. Corporations could take additional responsibility to train their employees into roles that are likely to remain Onshore. Proactive planning can help reduce a lot of anxiety and stress among employees and lead to higher Job satisfaction.

Additional Embodiments of the “calculator” could be programmed and integrated with an organization's HRMS or Cost rationalization software that helps manage resources globally.

What is claimed:

1. A web based offshorability probability calculation system to analyze an individual's job comprising of:
a) a calculator that can be accessed on a web browser using an internet enabled hardware device capable of taking user inputs, processing, storing and displaying output;
b) a user interface allowing users to select a plurality of options depending upon nature of their jobs, as defined in the key criteria;
c) a decision matrix that assigns non linear weights to each option the user selects;
d) a calculation engine that is programmed to dynamically process and display the offshorability results and their analysis in real time in form of a score, probability and analysis of any barriers to offshoring.

2. The system of claim 1, wherein some of key criterion carrying a weightage in offshoring decision comprise of education requirements for the job, department size and salary range.

3. The system of claim 1, wherein seasonal nature of job and attrition levels in a profession carry a weightage in final score.

4. The system of claim 1, wherein job duties related criterion comprise of percentage of time spent on computer, telephone or internet, face to face meeting requirements with clients or management, and travel requirements of the job.

5. The system of claim 1, wherein training requirements to learn job duties, confidential data handling, environment complexity and intellectual property issues carry relevant weightage in the final offshorability analysis.

6. The system of claim 1, wherein calculator is programmed to overrule offshore outsourcing of any job owing to technical or regulatory barriers, comprising of security clearance requirements, federal or state government jobs with offshoring restrictions or any special licensing requirements.

7. The system of claim 1, wherein a large number of concurrent users can simultaneously access the job analysis tool via internet access on their web browsers.

8. The system of claim 1, wherein HTML and JavaScript based calculation engine uses active scripting on client side to dynamically change the offshorability results output with each user input selection.

9. A spreadsheet based job analysis system comprising of:
a) a Microsoft EXCEL based calculator that can be downloaded and accessed on a personal computer or laptop capable of taking user inputs, processing, storing and displaying output;
b) a user interface allowing users to select a plurality of options depending upon nature of their jobs, as defined in the key criteria;
c) a decision matrix that assigns non linear weights to each option the user selects;
d) a calculation engine that is programmed to dynamically process and display the offshorability results and their analysis in real time in form of a score, probability and analysis of any barriers to offshoring.

10. The system of claim 9, wherein some of key criterion carrying a weightage in offshoring decision comprise of education requirements for the job, department size and salary range.

11. The system of claim 9, wherein seasonal nature of job and attrition levels in a profession carry a weightage in final score.

12. The system of claim 9, wherein job duties related criterion comprise of percentage of time spent on computer, telephone or internet, face to face meeting requirements with clients or management, and travel requirements of the job.

13. The system of claim 9, wherein training requirements to learn job duties, confidential data handling, environment complexity and intellectual property issues carry relevant weightage in the final offshorability analysis.

14. The system of claim 9, wherein calculator is programmed to overrule offshore outsourcing of any job owing to technical or regulatory barriers, comprising of security clearance requirements, federal or state government jobs with offshoring restrictions or any special licensing requirements.

15. The system of claim 9, wherein Users can customize the Microsoft EXCEL based calculator by altering the Decision Weights or adding additional criteria based their needs or to create additional embodiments of the tool.

16. The system of claim 9, wherein EXCEL based calculation engine dynamically changes the offshorability results output with each user input selection.

17. A method for analyzing individual jobs for offshorability comprising of:
a) selecting key criteria that determine a jobs offshorability;
b) determining sub-criterion, a plurality of options depending upon nature of jobs, as defined by key criteria;
c) building a decision matrix that assigns non linear weights to each option defined in the key criteria;
d) scoring and analyzing the scores for offshorability and existence of any technical or regulatory barrier to offshoring.

18. The method of claim 17, wherein some of key criterion carrying a weightage in offshoring decision comprise of education requirements for the job, department size, salary range, seasonal nature of job and attrition levels in a profession

19. The method of claim 17, wherein job duties related criterion comprise of percentage of time spent on computer, telephone or internet, face to face meeting requirements with clients or management, and travel requirements of the job.

20. The method of claim 17, wherein training requirements to learn job duties, confidential data handling, environment complexity and intellectual property issues carry relevant weightage in the final offshorability analysis.
